(19) United States
(12) Patent Application Publication
(10) Pub. No.: US 2018/0145372 A1
(43) Pub. Date: May 24, 2018

(54) NON-AQUEOUS ELECTROLYTE AND LITHIUM ION BATTERY

(71) Applicant: BYD COMPANY LIMITED, SHENZHEN (CN)

(72) Inventors: FEIYAN QIAO, SHENZHEN (CN); SHENG WANG, SHENZHEN (CN)

(21) Appl. No.: 15/874,234

(22) Filed: Jan. 18, 2018

Related U.S. Application Data
(63) Continuation of application No. PCT/CN2016/097393, filed on Aug. 30, 2016.

(30) Foreign Application Priority Data
Aug. 31, 2015 (CN) 201510548371.8

(51) Int. Cl. H01M 10/0567; H01M 4/38; H01M 4/505; H01M 4/525; H01M 10/0525; H01M 4/04

(52) U.S. Cl. CPC H01M 10/0567; H01M 4/382; H01M 4/505; H01M 2004/027; H01M 10/0525; H01M 4/04; H01M 4/525

(57) ABSTRACT

Provided are a non-aqueous electrolyte and a lithium ion battery containing the same. The non-aqueous electrolyte includes a lithium salt, a non-aqueous solvent and a first additive, the first additive includes phosphorothionates having a structure shown as formula (1):

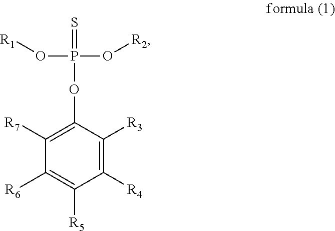

each R₁ and R₂ are selected from a group consisting of —(CH₂)n-CH₃, —(CH₂)n-CF₃, —NO₂ and —SO₃, n is an integer of 0 to 4; each R₃ to R₇ are selected from a group consisting of —CN, —F, —Cl, —Br, —CF₃, —NO₂ and —H; and at least one of R₃ to R₇ is selected from —CN, —F, —Cl, —Br, —CF₃ and —NO₂.

### CROSS-REFERENCE TO RELATED APPLICATION

The application is a continuation application of International Application No. PCT/CN2016/097393, filed on Aug. 30, 2016, which is based on and claims priority to and benefits of Chinese Patent Applications No. 201510548371.8, filed with the State Intellectual Property Office of P. R. China on Aug. 31, 2015. The entire content of the above-identified applications are incorporated herein by reference.

### TECHNICAL FIELD

The present disclosure relates to the field of lithium ion batteries, and in particular to a non-aqueous electrolyte and a lithium ion battery containing the same.

### BACKGROUND

Recently, secondary lithium ion batteries with high energy density have become focus of people's attention. Consequently, people also find some new active materials available for the secondary lithium ion batteries. For instance, a high-voltage anode material LiNi_{0.5}Mn_{1.5}O₄ of which a voltage-platform is about 4.7V was once disclosed in the prior art, the increase of a working voltage thereof directly improves the service power of a battery, and the material is of great practical significance. However, at the present stage, most of lithium battery electrolyte systems may be steadily used only under the voltage of 4.5V or less. When the working voltage exceeds 4.5V, the electrolyte systems may be oxidatively decomposed, and as a result, the battery couldn't work normally. Therefore, existing electrolytes seriously hinder wide application of high-voltage anode materials.

### SUMMARY

In view of the above technical problems, the present disclosure provides in embodiments a novel non-aqueous electrolyte. The novel non-aqueous electrolyte includes phosphorothionates having a unique structure in the present disclosure. Electrons in a molecule of the unique-structured phosphorothionates can be automatically gathered to a certain end of the molecule, such that the whole molecule is negatively charged. When two ends of a battery generate voltages, the molecule will be instantaneously adsorbed to the surface of an anode, and therefore the anode is protected from contacting the electrolyte, thereby isolating a reaction therebetween, and stopping degradation of the electrolyte on the surface of the anode.

Specifically, the present disclosure provides a non-aqueous electrolyte, including a lithium salt, a non-aqueous solvent and a first additive including phosphorothionates having a structure shown as formula (1):

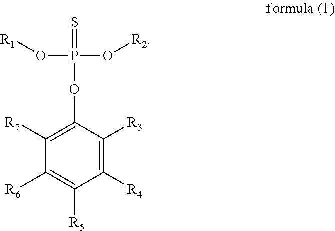

each R₁ and R₂ are selected from a group consisting of —(CH₂)n-CH₃, —(CH₂)n-CF₃, —NO₂ and —SO₃; n is an integer of 0 to 4; each R₃ to R₇ are selected from a group consisting of —CN, —F, —Cl, —Br, —CF₃, —NO₂ and —H; and at least one of R₃ to R₇ is selected from —CN, —F, —Cl, —Br, —CF₃ and —NO₂.

In the present disclosure, the first additive of the present disclosure is added into a non-aqueous electrolyte. The first additive includes an organic phosphorothionate molecule having a structure shown as formula (1). One end of the molecule is a benzene ring with a strongly polar group, a strong electron withdrawing effect is provided, and therefore the whole molecule will be negatively charged. After a voltage is generated between an anode and cathode of a battery, the first additive will be instantaneously adsorbed to the surface of the anode, and the adsorption capacity will be increased along with the increase of the anode voltage. After the first additive is adsorbed on the surface of the anode, a contact between the anode and the electrolyte can be cut off, and a reaction therebetween is stopped, thereby preventing degradation of the electrolyte on the surface of the anode, and achieving a function of protecting film forming of the anode.

The present disclosure further provides in embodiments a lithium ion battery, which includes a housing, a core accommodated in the housing and having an anode, a cathode and a separator disposed between the anode and the cathode, and a non-aqueous electrolyte above-mentioned which is also accommodated in the housing, the anode includes an anode active substance, the cathode includes a cathode active substance.

The present disclosure can effectively improve, by adding the first additive of the present disclosure such as the phosphorothionates having a structure shown as formula (1) into the non-aqueous electrolyte, the electric potential of oxidative decomposition of the non-aqueous electrolyte. The non-aqueous electrolyte of the present disclosure is configured to prepare a lithium ion battery, and the obtained battery not only has higher charge-discharge performance, but also is high in capacity retention ratio after cycle, low in deformation before and after cycle, and long in service life.

### DETAILED DESCRIPTION

Hereinafter, specific embodiments of the present disclosure will be described in detail. It is to be understood that the specific embodiments described herein are provided merely for the purpose of illustration and explanation and not intended to limit the scope of the present disclosure.

The present disclosure provides a non-aqueous electrolyte, including a lithium salt, a non-aqueous solvent and a first additive. The first additive includes phosphorothionates having a structure shown as formula (1):

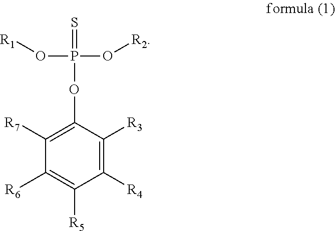

each R₁ and R₂ are selected from a group consisting of —(CH₂)n-CH₃, —(CH₂)n-CF₃, —NO₂ and —SO₃; n is an integer of 0 to 4; each R₃ to R₇ are selected from a group consisting of —CN, —F, —Cl, —Br, —CF₃, —NO₂ and —H; and at least one of R₃ to R₇ is selected from —CN, —F, —Cl, —Br, —CF₃ and —NO₂.

We found that the addition of the phosphorothionates having the structure shown as formula (1) of the present disclosure in the non-aqueous electrolyte can greatly improve the electric potential of oxidative decomposition of the non-aqueous electrolyte. The phosphorothionates having the structure shown as formula (1) of the present disclosure can be adsorbed to an anode of a battery in situ. When the voltage of the battery is higher, the phosphorothionates can be more firmly adsorbed; and when the voltage drops, desorption occurs. This kind of characteristic not only can form a protective film on the anode of the battery to prevent the electrolyte from being oxidized on the surface of the anode of the battery, but also does not have any impact on the performance of the electrolyte.

In some embodiments, R₅ is —CN or —NO₃, and R₃, R₄, R₆ and R₇ are hydrogen atoms.

In some embodiments, both R₁ and R₂ are methyl or both R₁ and R₂ are ethyl.

In some embodiments, both R₁ and R₂ are methyl, R₅ is —CN, and R₃, R₄, R₆ and R₇ are —H; and in this case, the phosphorothionates having the structure shown as formula (1) of the present disclosure is O-4-cyanophenyl O,O-dimethyl phosphorothionate.

In some embodiments, in the non-aqueous electrolyte, the first additive is of a content of about 0.1% to 10%, based on the total weight of the non-aqueous electrolyte. In some other embodiments, the first additive is of a content of about 0.5% to 1.5%. When the content of the first additive is over-high, the charge-discharge capacity of the battery will be affected, and when the content of the first additive is over-low, the electric potential of oxidative decomposition of the non-aqueous electrolyte is not obviously improved.

In some embodiments, the non-aqueous solvent may be selected from at least one of a carboxylic ester solvent, a carbonic ester solvent, a nitrile solvent or a ketone solvent. In some embodiments, the non-aqueous solvent is selected from one or more of ethyl methyl carbonate (EMC), dimethyl carbonate (DMC), diethyl carbonate (DEC), ethylene carbonate (EC), propylene carbonate (PC), butylene carbonate (BC), ethylene sulfite (ES), propylene sulfite (PS), diethyl sulfite (DES), γ-butyrolactone (BL), dimethyl sulfoxide (DMSO), ethyl acetate and methyl acetate. In some embodiments, the non-aqueous solvent is selected from one or more of carbonates such as EMC, DMC and DEC. In some specific embodiments, the non-aqueous solvent is a mixture of EMC, DMC and DEC, and a mass ratio of EMC to DMC to DEC is about 2:1:3 to 2:3:1.

When the content ratio of the first additive to the non-aqueous solvent falls within the above range, the prepared lithium ion battery may have a higher charge-discharge capacity, better cycle performance and longer service life.

In some embodiments, the lithium salt can be selected from one or more of LiPF₆, LiClO₄, LiBF₄, LiAsF₆, LiClO₄, LiSiF₆, LiAlCl₄, LiBOB, LiODFB, LiCl, LiBr, LiI, LiCF₃SO₃, Li(CF₃CO₂)₂N, Li(CF₃SO₂)₂N or Li(SO₂C₂F₅)₂N. In some embodiments, the lithium salt is of a weight of about 8.5 wt % to 18.5 wt % of the total weight of the electrolyte.

In some embodiments, the present disclosure adopts LiPF₆ as the lithium salt, the concentration thereof is about 8.5 wt % to 18.5 wt %, and optimally about 10 wt % to 16 wt %.

In some embodiments, the non-aqueous electrolyte further includes a second additive, and the second additive includes LiBOB or vinylene carbonate.

Because vinylene carbonate or LiBOB has excellent cathode film forming performance, an excellent SEI film can be formed on the surface of a cathode by using the vinylene carbonate or LiBOB as the second additive, and the cathode is protected from being eroded by the electrolyte. The phosphorothionates having a structure shown as formula (1) in the present application, serving as the first additive, is added into the non-aqueous electrolyte to be mainly capable of forming a protective film on the surface of an anode material so as to isolate a side reaction between the anode material and the electrolyte. Thus, the cooperative usage of the first additive and the second additive can protect the anode and cathode of the battery simultaneously. By applying the non-aqueous electrolyte, to which the first additive and the second additive are added, to a battery, the prepared battery may have high energy density and high charge-discharge capacity. Particularly, cooperative application of the non-aqueous electrolyte and a high-voltage electrode material to a high-voltage system may achieve an extremely obvious effect.

In some embodiments, a mass ratio of the first additive to the second additive is about 1:3 to 3:1. The inventor of the present application found that the prepared battery has, when the mass ratio of the first additive to the second additive is controlled within the above range, optimal cycle performance and charge-discharge performance.

In some embodiments, all the components including the lithium salt, the non-aqueous solvent and various additives are mixed in argon gloves. An exemplary method of the present disclosure includes: dissolving the lithium salt in the non-aqueous solvent inside an argon glove box; and then adding the first additive of the present disclosure or a mixture of the first additive and the second additive so as to obtain a non-aqueous electrolyte.

The present disclosure also provides a lithium ion battery, which includes a housing, a core accommodated in the housing and having an anode, a cathode and a separator disposed between the anode and the cathode, and a non-aqueous electrolyte mentioned above. The anode includes an anode collector and an anode material disposed on the surface of the anode collector. The anode material includes an anode active substance, an anode conductive agent and an anode binder. The anode active substance, the anode conductive agent and the anode binder may be an anode active substance, an anode conductive agent and an anode binder. In some embodiments, the anode active substance is one or more of LiNi_{0.5}Mn_{1.5}O₄, LiNi₁₋ₓMnₓO₂, LiNi₁₋ₓCoₓO₂, LiNi_{1-y-z}Co_{y}Mn_{z}O₂ and LiNi_{1-y-z}Co_{y}Al_{z}O₂, where 0≤x≤1, y≥0, z≥0, and y+z≤1. The anode conductive agent is one or more of acetylene black and a carbon nano tube. The anode binder is polyvinylidene fluoride. The cathode includes a cathode collector and a cathode material disposed on the surface of the cathode collector. The cathode material includes a cathode active substance and a cathode binder. The cathode material may also selectively include a cathode conductive agent. The cathode conductive agent may be identical to or different from the anode conductive agent. The cathode active substance and the cathode binder may be a cathode active substance and a cathode binder. For instance, the cathode active substance may be a lithium metal, a lithium-aluminum alloy, graphite, modified graphite, hard carbon, modified hard carbon or the like. In some embodiments, the cathode active substance is a lithium metal sheet.

The present disclosure only relates to improvement on an electrolyte of an existing lithium ion battery, and does not specially limit other components and structure of the lithium ion battery.

A preparation method for a lithium ion battery of the present disclosure includes: providing a separator between a prepared anode and cathode; winding or folding the separator, anode and cathode to form a core; accommodating the core in a battery housing; injecting an electrolyte; and then sealing the battery housing to prepare a lithium ion battery.

The non-aqueous electrolyte provided by the present disclosure has better high-voltage resistance and higher electric potential of oxidative decomposition. Meanwhile, a battery prepared from the non-aqueous electrolyte has a better cycle performance and charge-discharge performance.

The lithium ion battery provided by the present disclosure has a higher energy density and first charge-discharge performance, and has an excellent storage performance and cycle performance at high temperatures.

The non-aqueous electrolyte and the lithium ion battery containing the same of the present disclosure will be further illustrated below in conjunction with embodiments.

### Embodiment 1

(1) Preparation of Non-Aqueous Electrolyte:

100 parts by weight of non-aqueous solvents from EC, DEC and DMC in a ratio of 2:1:3 in an argon glove box were prepared, 12 parts by weight of LiPF₆ were dissolved into the prepared non-aqueous solvents, and then 1 part by weight of O-4-cyanophenyl O,O-dimethyl phosphorothionates (phosphorothionates having structure shown as formula (1) of the present disclosure was added, both R₁ and R₂ are —CH₃, R₅ is —CN, and R₃, R₄, R₆ and R₇ are hydrogen atoms), thereby obtaining a non-aqueous electrolyte of the present embodiment, which was recorded as C1; and

(2) Preparation of Lithium Ion Battery:

An anode active substance (LiNi_{0.5}Mn_{1.5}O₄), acetylene black and polyvinylidene fluoride in a ratio of 90:5:5 were uniformly mixed to obtain a mixture, and then the mixture was pressed onto an aluminum foil to obtain an anode sheet; a lithium metal sheet was provided as a cathode sheet; and a PE/PP composite separator was provided as an ion exchange membrane, and a button battery S1 was made from the non-aqueous electrolyte C1 of the present embodiment

### Embodiment 2

A non-aqueous electrolyte and a button battery were prepared using the steps identical to those in embodiment 1, except that: O-4-cyanophenyl O,O-dimethyl phosphorothionate was replaced with 1 part by weight of O-(2,6-dichloro-4-tolyl)O,O-dimethyl phosphorothionates (phosphorothionates having a structure shown as formula (1) of the present disclosure, all of R₁, R₂ and R₅ are —CH₃, both R₃ and R₇ are —Cl, and both R₄ and R₆ are —H) in step (1), thereby preparing a non-aqueous electrolyte C2 and a button battery S2.

### Embodiment 3

A non-aqueous electrolyte and a button battery were prepared using the steps identical to those in embodiment 1, except that: 1 part by weight of vitamin C was further added in step (1), thereby preparing a non-aqueous electrolyte C3 and a button battery S3.

### Embodiment 4

A non-aqueous electrolyte and a button battery were prepared using the steps identical to those in embodiment 1, except for that: 0.5 parts by weight of vitamin C and 0.5 parts by weight of LiBOB were further added in Step (1), thereby preparing a non-aqueous electrolyte C4 and a button battery S4.

### Embodiment 5

A non-aqueous electrolyte and a button battery were prepared using the steps identical to those in embodiment 1, except that: 0.5 parts by weight of LiBOB were further added in step (1), thereby preparing a non-aqueous electrolyte C5 and a button battery S5.

### Embodiment 6

A non-aqueous electrolyte and a button battery were prepared using the steps identical to those in embodiment 1, except for that: in step (2), the anode active substance was replaced with LiNi_{0.5}Mn_{0.5}O₂, and the cathode active substance was replaced with a lithium metal sheet, thereby preparing a non-aqueous electrolyte C6 and a button battery S6.

### Embodiment 7

A non-aqueous electrolyte and a button battery were prepared using the steps identical to those in embodiment 1. Differently, in Step (2), an anode active substance was replaced with LiNi_{0.5}Mn_{0.5}O₂, and a cathode active substance was replaced with graphite, thereby preparing a non-aqueous electrolyte C7 and a button battery S7.

### Comparison Example 1

A non-aqueous electrolyte and a button battery were prepared using the steps identical to those in embodiment 1, except that: in step (1), O-4-cyanophenyl O,O-dimethyl phosphorothionate was replaced with 0.5 parts by weight of p-tolunitrile, thereby preparing a non-aqueous electrolyte DC1 and a button battery DS1.

### Comparison Example 2

A non-aqueous electrolyte and a button battery were prepared using the steps identical to those in embodiment 1, except that: in step (1), O-4-cyanophenyl O,O-dimethyl phosphorothionate was replaced with 0.8 parts by weight of diethyl(cyanomethyl)phosphonate, thereby preparing a non-aqueous electrolyte DC2 and a button battery DS2.

### Comparison Example 3

A non-aqueous electrolyte and a button battery were prepared using the steps identical to those in embodiment 1, except that: in step (1), 12 parts by weight of O-4-cyanophenyl O, O-dimethyl phosphorothionate were added, thereby preparing a non-aqueous electrolyte DC3 and a button battery DS3.

### Comparison Example 4

A non-aqueous electrolyte and a button battery were prepared using the steps identical to those in embodiment 1, except that: in step (1), 0.08 parts by weight of O-4-cyanophenyl O, O-dimethyl phosphorothionate were added, thereby preparing a non-aqueous electrolyte DC4 and a button battery DS4.

### Performance Test

(1) Test on Electric Potential of Oxidative Decomposition of Electrolyte Under High Voltage:

The non-aqueous electrolytes C1 to C7 prepared in the embodiments 1 to 7 and the non-aqueous electrolytes DC1 to DC4 prepared in the comparison examples 1 to 4 were placed into a container, using a platinum sheet as a working electrode, lithium sheets as a counter electrode and a reference electrode, tests were performed by using an electrochemical workstation, a linear sweep voltammetry (LSV) program was adopted for performing sweep, an open circuit voltage (OCV) was tested under a sweep interval of 3 to 7V, and a sweep rate of 2 mV, a test result is shown in Table 1.

TABLE 1

| Electrolyte | Oxidative decomposition/V |
|---|---|
| C1 | 5.8 |
| C2 | 5.6 |
| C3 | 5.3 |
| C4 | 5.2 |
| C5 | 5.3 |
| C6 | 5.8 |
| C7 | 5.7 |
| DC1 | 4.7 |
| DC2 | 4.6 |
| DC3 | 6.0 |
| DC4 | 4.9 |

(2) Test on Specific Capacity of Battery Under High Voltage:

All experimental batteries S1 to S7 and DS1 to DS4 were charged under a constant current of 0.1 C at a normal temperature until a cutoff voltage reached 4.9V, these batteries were discharged under the same current until the cutoff voltage reached 3.0V, and a charge-discharge capacity was recorded, a result was shown in Table 2.

(3) Test on Battery Cycle:

These batteries S1 to S7 and DS1 to DS4 were installed on a secondary battery performance tester BS-9300. These batteries were charged under a constant current of 1 C and a constant voltage until the cutoff voltage reaches 4.9V, and then was rested for 5 minutes. Next, these batteries were discharged under a current of 1 C until the cutoff voltage reached 3.0V, and then were charged under a constant current of 1 C and a constant voltage until the cutoff voltage reached 4.9V. These charge and discharge steps were repeated for 100 times. After the cycle was finished, the temperature of these batteries returned to the room temperature, then these batteries were fully charged under a current of 1 C, and then discharged under a current of 0.2 C until the cutoff voltage reached 3.0V, thereby obtaining a residual capacity. A capacity retention rate was obtained by dividing the residual capacity by a first cycle capacity, and a result was shown in Table 2.

TABLE 2

| | | | | Capacity |
|---|---|---|---|---|
| | | First | First charge- | retention rate |
| Battery | First charge | discharge | discharge | after cycle for |
| number | capacity/mAh | capacity/mAh | efficiency/% | 100 times/% |
| S1 | 133 | 148 | 89.8 | 85 |
| S2 | 125 | 150 | 83.2 | 78 |
| S3 | 126 | 147 | 85.7 | 75 |
| S4 | 115 | 148 | 77.7 | 70 |
| S5 | 120 | 140 | 85.7 | 80 |
| S6 | 124 | 144 | 86.1 | 75 |
| S7 | 124 | 146 | 84.9 | 70 |
| DS1 | 70 | 110 | 63.6 | 30 |
| DS2 | 75 | 109 | 68.8 | 32 |
| DS3 | 90 | 140 | 64.3 | 30 |
| DS4 | 85 | 175 | 48.6 | 25 |

From Table 1 and Table 2, it can be seen that the minimum electric potential of oxidative decomposition of the non-aqueous electrolyte provided by the present disclosure is 5.2V, while the electric potential of oxidative decomposition of the non-aqueous electrolytes, to which p-tolunitrile and diethyl(cyanomethyl)phosphonate are added, in comparison example 1 and comparison example 2 are only 4.6V and 4.7V, and the content of the phosphorothionates having a structure shown as Formula (1) of the present disclosure, added similarly to the comparison example 3 and the comparison example 4, is higher or lower than the content range of the present application. Although the electric potential of oxidative decomposition of the non-aqueous electrolyte can be still improved, we found that when the non-aqueous electrolyte is applied to a battery, the cycle performance and charge-discharge performance of the battery are affected. Meanwhile, from Table 2, it can also be seen that the maximum capacity retention rate of a battery sample with the electrolyte provided according to the present disclosure after repeating for 100 times is 85%, the minimum capacity retention rate is 70%, and the maximum capacity retention rate of battery samples prepared in the comparison examples after repeating for 100 times is only 32%. Thus, it can be seen that the electrolyte provided by the present disclosure has a good high-voltage resistance, and the cycle performance of the battery with the electrolyte provided by the present disclosure is effectively improved.

While the present disclosure has been described in detail with reference to preferred embodiments hereinbefore, the present disclosure is not limited to particular details in the above-described embodiments. Various modifications made to the technical solution of the present disclosure without departing from the scope of the present disclosure fall within the protection scope of the present disclosure.

It is to be noted that the specific technical features described in the above detailed embodiments may be combined in any suitable manner without contradiction. To avoid unnecessary repetition, the various possible combinations are not further described in the present disclosure again.

In addition, various embodiments of the present disclosure may be combined in any way without departing from the spirit of the present disclosure, and such combinations are also embraced in the protection scope of the present disclosure.

What is claimed is:

1. A non-aqueous electrolyte, comprising a lithium salt, a non-aqueous solvent and a first additive, wherein the first additive includes phosphorothionates having a structure shown as formula (1): 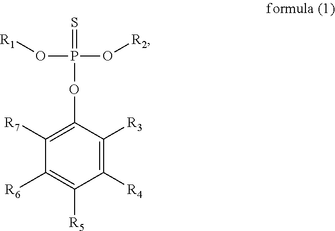
wherein
each R₁ and R₂ are selected from a group consisting of —(CH₂)n-CH₃, —(CH₂)n-CF₃, —NO₂ and —SO₃,
n is an integer of 0 to 4;
each R₃ to R₇ are selected from a group consisting of —CN, —F, —Cl, —Br, —CF₃, —NO₂ and —H; and
at least one of R₃ to R₇ is selected from —CN, —F, —Cl, —Br, —CF₃ and —NO₂.

2. The non-aqueous electrolyte according to claim 1, wherein R₅ is —CN or —NO₂, and R₃, R₄, R₆ and R₇ are —H.

3. The non-aqueous electrolyte according to claim 1, wherein both R₁ and R₂ are methyl or both R₁ and R₂ are ethyl.

4. The non-aqueous electrolyte according to claim 1, wherein both R₁ and R₂ are methyl, R₅ is —CN, and R₃, R₄, R₆ and R₇ are —H.

5. The non-aqueous electrolyte according to claim 1, wherein the first additive is of a content of about 0.1% to about 10% based on a total mass of the non-aqueous electrolyte.

6. The non-aqueous electrolyte according to claim 1, wherein the first additive is of a content of about 0.5% to about 1.5% based on a total mass of the non-aqueous electrolyte.

7. The non-aqueous electrolyte according to claim 1, further comprising a second additive including LiBOB or vinylene carbonate.

8. The non-aqueous electrolyte according to claim 7, wherein a mass ratio of the first additive to the second additive is 1:3 to 3:1.

9. A lithium ion battery, comprising:
a housing,
a core accommodated in the housing, wherein the core include an anode comprising an anode active substance, a cathode comprising a cathode active substance, and a separator disposed between the anode and the cathode, and
a non-aqueous electrolyte accommodated in the housing, wherein the non-aqueous electrolyte comprises a lithium salt, a non-aqueous solvent and a first additive, wherein the first additive includes phosphorothionates having a structure shown as formula (1): 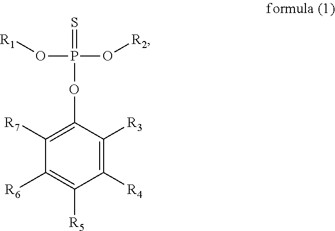
wherein
each R₁ and R₂ are selected from a group consisting of —(CH₂)n-CH₃, —(CH₂)n-CF₃, —NO₂ and —SO₃,
n is an integer of 0 to 4;
each R₃ to R₇ are selected from a group consisting of —CN, —F, —Cl, —Br, —CF₃, —NO₂ and —H; and
at least one of R₃ to R₇ is selected from —CN, —F, —Cl, —Br, —CF₃ and —NO₂.

10. The lithium ion battery according to claim 9, wherein the anode active substance is at least one selected from a group consisting of LiNi_{0.5}Mn_{1.5}O₄, LiNi₁₋ₓMnₓO₂, LiNi₁₋ₓCoₓO₂, LiNi_{1-y-z}Co_{y}Mn_{z}O₂ and LiNi_{1-y-z}Co_{y}Al_{z}O₂, wherein 0≤x≤1, y≥0, z≥0, and y+z≤1; and the cathode active substance includes lithium metal.

11. The lithium ion battery according to claim 9, wherein R₅ is —CN or —NO₂, and R₃, R₄, R₆ and R₇ are —H.

12. The lithium ion battery according to claim 9, wherein both R₁ and R₂ are methyl or both R₁ and R₂ are ethyl.

13. The lithium ion battery according to claim 9, wherein both R₁ and R₂ are methyl, R₅ is —CN, and R₃, R₄, R₆ and R₇ are —H.

14. The lithium ion battery according to claim 9, wherein the first additive is of a content of about 0.1% to about 10% based on a total mass of the non-aqueous electrolyte.

15. The lithium ion battery according to claim 9, wherein the first additive is of a content of about 0.5% to about 1.5% based on a total mass of the non-aqueous electrolyte.

16. The lithium ion battery according to claim 9, further comprising a second additive including LiBOB or vinylene carbonate.

17. The lithium ion battery according to claim 16, wherein a mass ratio of the first additive to the second additive is 1:3 to 3:1.

18. A method for preparing a non-aqueous electrolyte, comprising:
dissolving a lithium salt in a non-aqueous solvent inside an argon glove box to obtain a mixture; and
adding a first additive to the obtained mixture, wherein the first additive includes
phosphorothionates having a structure shown as formula (1): 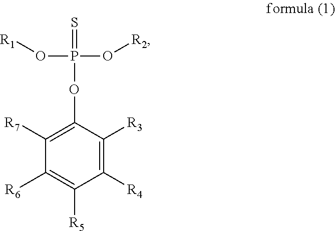
wherein
each R₁ and R₂ are selected from a group consisting of —(CH₂)n-CH₃, —(CH₂)n-CF₃, —NO₂ and —SO₃,
n is an integer of 0 to 4;
each R₃ to R₇ are selected from a group consisting of —CN, —F, —Cl, —Br, —CF₃, —NO₂ and —H; and
at least one of R₃ to R₇ is selected from —CN, —F, —Cl, —Br, —CF₃ and —NO₂.

19. The method according to claim 18, prior to adding the first additive, further comprising:
mixing the first additive and a second additive to create a second mixture; and
adding the second mixture to the obtained mixture, wherein the second additive includes LiBOB or vinylene carbonate, and a mass ratio of the first additive to the second additive is 1:3 to 3:1.

20. The method according to claim 18, wherein both R₁ and R₂ are methyl or both R₁ and R₂ are ethyl, R₅ is —CN or —NO₂, and R₃, R₄, R₆ and R₇ are —H.
